(19) United States
(12) Patent Application Publication
(10) Pub. No.: US 2016/0110746 A1
(43) Pub. Date: Apr. 21, 2016

(54) System for Valuing Content

(71) Applicant: Steven Roundtree, Orlando, FL (US)

(72) Inventor: Steven Roundtree, Orlando, FL (US)

(21) Appl. No.: 14/519,602

(22) Filed: Oct. 21, 2014

(51) Int. Cl. G06Q 30/02

(52) U.S. Cl. CPC G06Q 30/0206

(57) ABSTRACT

Disclosed is a system and methods for valuing content by a crowd comprising a valuation platform connected to a plurality of users over a network, which may be a communication network. The valuation platform comprises a content grouping engine to enable the receipt of content from at least one user device; group the content into categories of content and determine a market value for any given category of content. The system also comprises a value distribution engine to enable the distribution of at least a portion of the market value to content based on approval received from a crowd of users as to any given content. The system may comprise an incentive engine to incentivize gross and quality participation of the crowd. Methods are disclosed for valuing content.

### COPYRIGHT

Copyright—A portion of the disclosure of this document contains material that is subject to copyright protection. The copyright owner has no objection to the facsimile reproduction by anyone of the patent document or the patent disclosure, as it appears in publically available Patent and Trademark Office patent files or records, but otherwise reserves all copyright rights whatsoever. The following notice applies to the software, data, and/or screenshots which may be described below and in the drawings that form a part of this document: Copyright Steven Roundtree, All Rights Reserved.

### BACKGROUND

Across the globe, individuals and companies create content. This content may be visual, auditory (music), or creative writings, to name a few. While a small percentage of content creators go on to become notable and well compensated, generally speaking liberal arts are considered low income producing professions, thus harkening the phrase, “starving artist.”

For example, an artist may create a wall mural. If the artist wishes to make a living off his craft, the only known methods by which he or she may do so are to create a portfolio and solicit buyers for mural based services.

### SUMMARY

A system and method is disclosed for valuing content. The system improves on existing systems by eliminating peer bias and “robo-voting,” among other distinctions. In the preferred embodiment, the system further comprises means for allowing users to earn financial return for posting content determined by the system to have value (monetization). In this embodiment, the system comprises modules that when communicatively coupled over a network and with user participation, result in a unique incentive for a crowd based valuation of users' content, and ultimately, a financial return to the users corresponding to the achieved value of their posted content.

The valuation itself is novel, as it is not necessarily based on the “value” the content would achieve were the content sold in a traditional retail environment. For example, the current retail prices for mural artwork would be based on prices those services (the physical painting of a mural) are currently selling for in a given locale. In contrast, the system values content via subjective human opinion, across locales. For that reason, a mural artist (hypothetical User A) may actually have her mural valued at an amount which differs from the retail value of mural services. For this reason, the system produces a unique and distinct valuation.

The system may be viewed in the alternative as a system and method for creating a. specific monetary value to correspond with crowd-based subjective opinion. Current social media systems permit users to “like” others' content. One may think that simply adding the number of likes a content receives could be correlated to its value. This type of simplistic system would not result in a true value. Existing systems have inherent peer bias. For instance, people may feel compelled to vote for what others vote for. Or they may feel compelled to show support for a particular person's content. Existing systems are also cheatable. Contests based on votes and likes suffer from “robo-voting” and voter exchanges which purposefully cheat and misrepresent the actual number of votes.

The system disclosed avoids these possibilities in a number of ways. For instance, the system limits the number “likes” (also termed “Approval Units” (AU)) available to be used at any given time to a discrete, specific number. In the preferred embodiment, the number of AU's available to be used by any user equals the number of contents uploaded in the system in a particular “market” or category of content in another safeguard, the number of times a particular user may like anything is limited to a certain predetermined quantity per unit time. Further, all content displayed to users on the system is anonymized, randomized, and preferably non-searchable. Therefore users may only like what the system randomly places before them without knowledge of the origin of the content. Further, there is no information given to users as to how many likes a particular content has achieved. Therefore, users are forced to opine on the content in the absence of the status of the peer approval of any particular content.

The system is constructed in a “feed-forward” manner which perpetuates participation by users for the use of their subjective opinions in valuing content. The system, through several processes described in the Detailed Description, does this by requiring users who wish to use the system to monetize their content to also participate in the valuation of other users' content.

Currently, celebrities obtain advertisement contracts based on several factors, one of which is the number of followers that celebrity has on social media. The contract is based on the assumption that the number of followers equals the number of potential consumers reached by the advertisement. This assumption has weaknesses. For one, the value of the consumers reached is unknown. A small number of followers might actually be disinterested initially in the celebrity, but following out of curiosity. Other followers may have initially be influenced by the celebrity, but over time, grew to dislike the celebrity and has been too busy to delete the celebrity from their list of followed accounts.

The value generated by the system may later be used as a guidepost for determining commercial price for the sale of the content, (for example, as the number of Twitter followers a celebrity has is a factor in determining soft value of that celebrity's value).

In one embodiment, the system allows for valuation of content which avoids the problem of peer bias.

In another embodiment the system comprises means for allowing users who do not post content to earn a financial reward for their participation, if they choose the most approved-of content.

In order to accomplish these ends, the system comprises a valuation platform comprising at least a processor, memory, and hardware for communicatively coupling the valuation platform to the at least one user device over a network. The valuation platform further comprising a content grouping engine to enable the receipt of content from at least one user device, group the content into categories of content, and determine a market value for any given category of content. The content grouping engine is coupled with a value distribution engine to enable the distribution of at least a portion of the market value to content based on approval received from a crowd of users as to any given content. Although not required, the system also preferably comprises an incentive engine for rewarding the crowd of users for participating in the approval of content.

The system is coupled via computer or computers to a banking institution for payment of the value of the content determined by the system to the user. The value of an individual content is the portion of the market value distributed to that content by the value distribution engine.

The system also includes methods fir performing the valuation of the content by a crowd. These methods are described in the detailed description and claims herein, which are incorporated by reference into this summary. The preferred embodiment values content via method whereby each content is assigned a predetermined base value, U, which may be monetary or virtual value. The market value for a particular category of content is the sum of the U for all content in that category. For every content uploaded, a corresponding predetermined number of AU's are generated. These AU's may be distributed or assigned to individual content by the crowd, based on their subjective opinion of the content. The value is then the number of AU's assigned to the content, multiplied by the base value, U.

The system is unique because the “value” of content is not necessarily “value” measured in terms of ordinary commercial sales. For instance, at any given time the “value” of a photograph of a mural does not necessarily depend on the commercial success of the underlying mural—that is, the value as determined by the system is not necessarily the price the mural would fetch on the streets for the sale of the mural services or the mural itself. The valuation may be viewed as a collective subjective valuation, although that is not to say that the system's valuation may not affect commercial price valuation at some point in the future.

The system is designed with a low barrier to entry to the system so as to incentivize use. For example, content posted to the system may only increase in value. Therefore, users have no disincentive for posting content. Content is valued based on AU's assigned to the content by the crowd, but peer bias in the valuation of the content is eliminated due to the lack of data available to users assigning AU's as to the content owner, number of AU's it has thus far received, and other variables. Users may not assign AU's to their own content or send hots or friends to like their content because the content is unsearchable and displayed at random. The system preferably also comprises an incentive engine which gives credits (“knacks”) to users who participate in the assignment of approval units to others' content. The IE also rewards the assignment of AU's by users to good content, not just random content.

### BRIEF DESCRIPTION OF THE DRAWINGS

FIG. 1 shows a high level block diagram of the system in accordance with an embodiment;

FIG. 2 shows an alternate high level view of the system, in accordance with an embodiment;

FIG. 3a shows a detailed view of the processes taking place at and between the various components of the system, in accordance with an embodiment;

FIG. 3b shows an alternate flow of the methods performed by the system with respect to the lifecycle of content;

FIG. 4 is a flow chart showing the process by which a user may upload first and subsequent content, in accordance with an embodiment;

FIG. 5 shows a diagram for determining Market Value M, in accordance with an embodiment;

FIG. 6 is a block diagram illustrating participation of users with the VDE, in accordance with an embodiment;

FIG. 7 illustrates the method for knack return at the IE, in accordance with an embodiment;

FIG. 8 is a schematic showing how the system's various components ensure unbiased participation of the crowd to value content, in accordance with an embodiment.

### DETAILED DESCRIPTION

Broadly, embodiments of the present invention disclose a system 100 adapted to perform crowd valuation of content (preferably online) by uniquely facilitating and incentivizing bias-controlled participation of the crowd. In addition to coming up with a value for content, the system 100 is also adapted to allow users who post content to realize a monetary gain in accordance with the value determined by the system, even where the user has made no initial monetary investment.

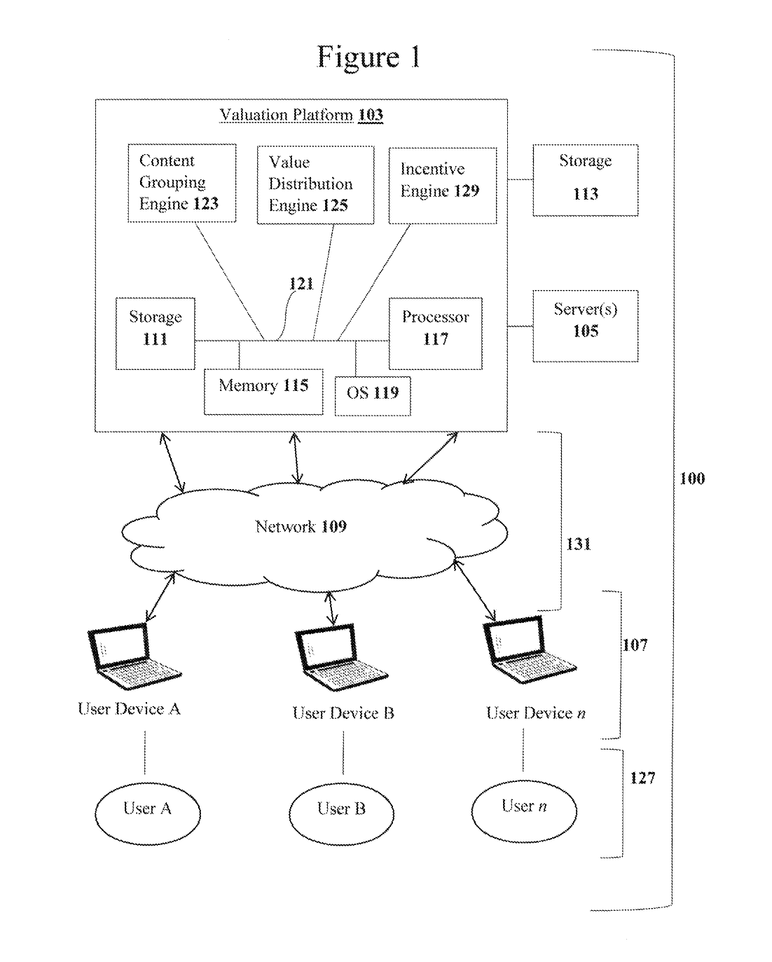

FIG. 1 shows the broad view block diagram of the system. Broadly speaking, the system 100 comprises a valuation platform 103 and a plurality of user devices 107 connected over the network 109. The valuation platform 103 also comprises at least two modules, the Content Grouping Engine (CGE) 123 and a Value Distribution Engine (VDE) 125. The preferred embodiment of the system further includes an Incentive Engine 129 (IE) to encourage gross participation of the crowd in valuing content as well as ensuring quality participation.

The CGE 123 receives content from a user and displays that content to subsequent users. The CUE 123 is also preferably responsible for creating categories of content called “markets” (for example the markets, “dog photos” or “music videos”) and generating the market value of a given market (market value is not content specific). It should be noted the term “market” is used as a commercial play on words, but there is no trading involved in the disclosed system, so these categories of content are not a “market” as that term applies to, for instance, the NYSE. A “market” may be a group or category of content.

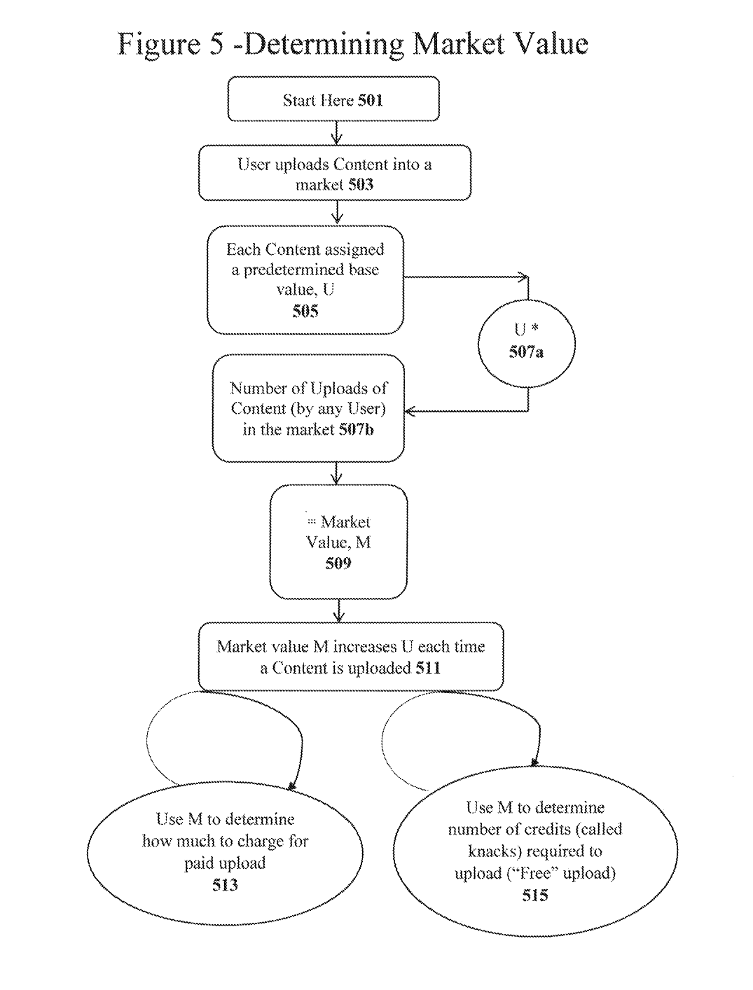

Each market will have a market value. Determining the market value is described in FIG. 5, discussed later.

Once a market is thusly created and managed at the CGE 123, the market value must be distributed, in whole or in part, to the individual content in that market. This is done at the Value Distribution Engine (VDE) 125. The VDE 125 is a module responsible for distributing a market's market value across individual content to come up with a value on individual content. This is done preferably in communication with another module, the IE 129 resulting in the system's uniquely incentivized, bias controlled, and self-policing crowd-based valuation. This is described in the Figures that follow.

The disclosure includes a system and method implemented by several computer systems, operating in tandem, over a communications network. The system 100 may be architected in a number of ways. For instance, it may include one or a plurality of servers 105. The valuation platform 103 itself may comprise a server having at least storage 111 communicatively coupled with memory 115, at least one processor 117 and an operating system 119 via bus 121. The system's 101 valuation platform 103 may also be hosted on more than one server, for instance remote server 105. The system 100 may have local storage 111 or remote storage 113.

The preferred embodiment of the system 100 operates within an electronic network requiring, among other things, controlled interaction with a plurality of users 127 over a network 109, which is a communication network, such as the Internet or in infra-organizational Intranet, or a combination of both.

Functionality of the Valuation Platform 103 includes functionality to receive, host, and broadcast/display content received from users via user devices 107 to other user devices 107. A user is able to upload content to the Valuation Platform 103 within a server-client network, in which the valuation platform 103 is hosted on a server 105 and the users use user devices 107 to connect to the Valuation Platform 103 via the network 109. The Valuation Platform 103 may comprise at least one server 105. Hardware that may be used to implement the Valuation Platform 103 of the system 100 is shown in FIG. 1 is described more fully below in the section, Architecture.

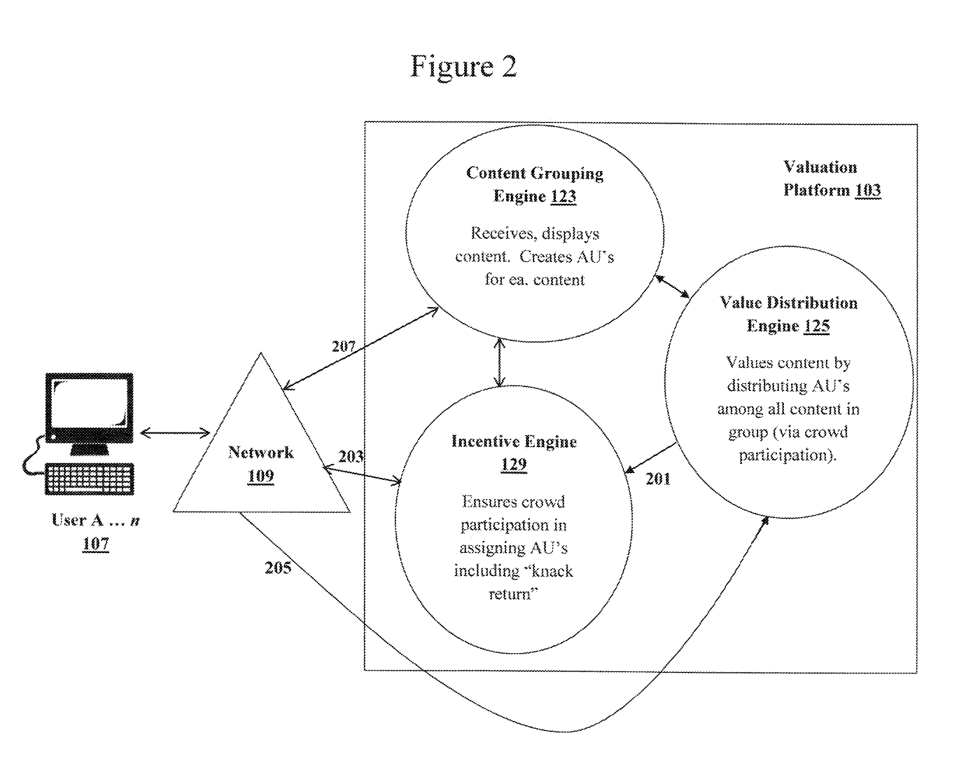

FIG. 2 is an alternate view of a high level flow between the various components of the preferred embodiment of the system. Users A . . . n 107 interact with the Valuation Platform 103 via network 109. There, three main modules (the CGE 123, VDE 125, and IE 129) work together to accomplish the following, including but not limited to 1) grouping or categorizing the content uploaded or posted to the system (at the CGE 123), 2) making the content available to subsequent users (also referred to herein as the “crowd”) (by the CGE 123 at the user devices 107), 4) receiving input from the crowd (at the VDE 125), 5) utilizing that input to value the content (at the VDE 125), and 5) ensuring there is sufficient crowd participation in the first place, as well as unbiased and quality crowd participation (at the IE 129).

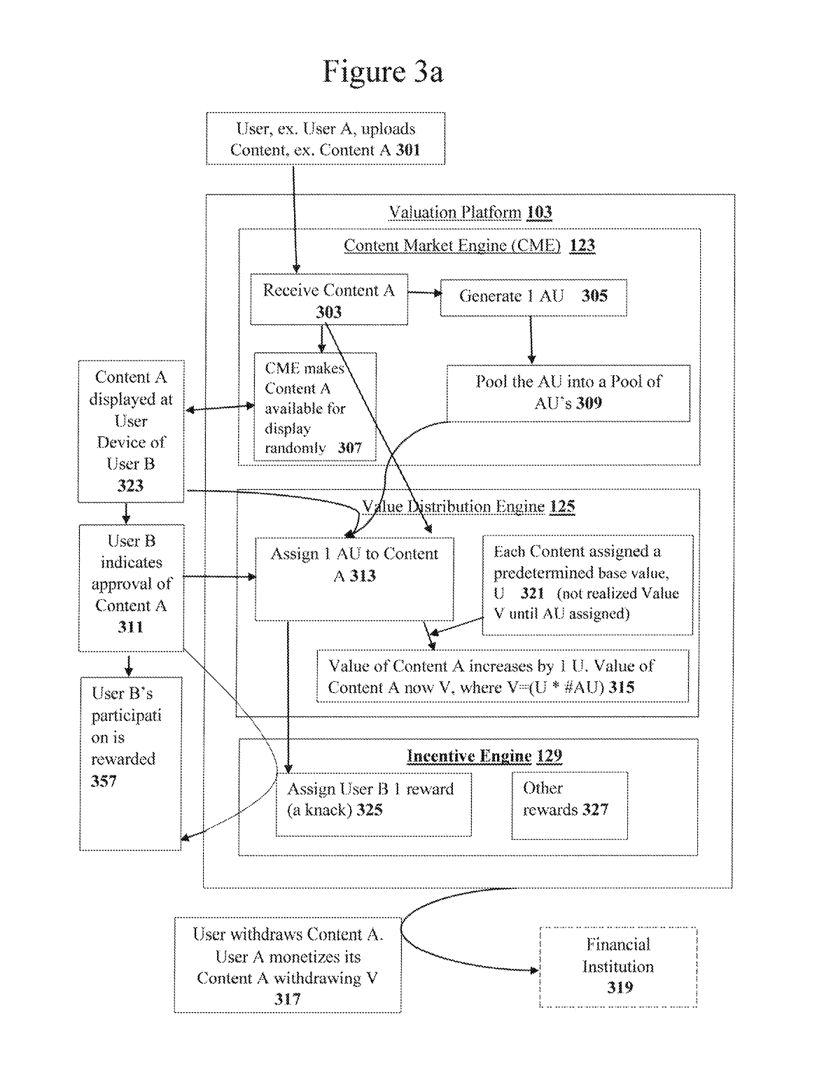

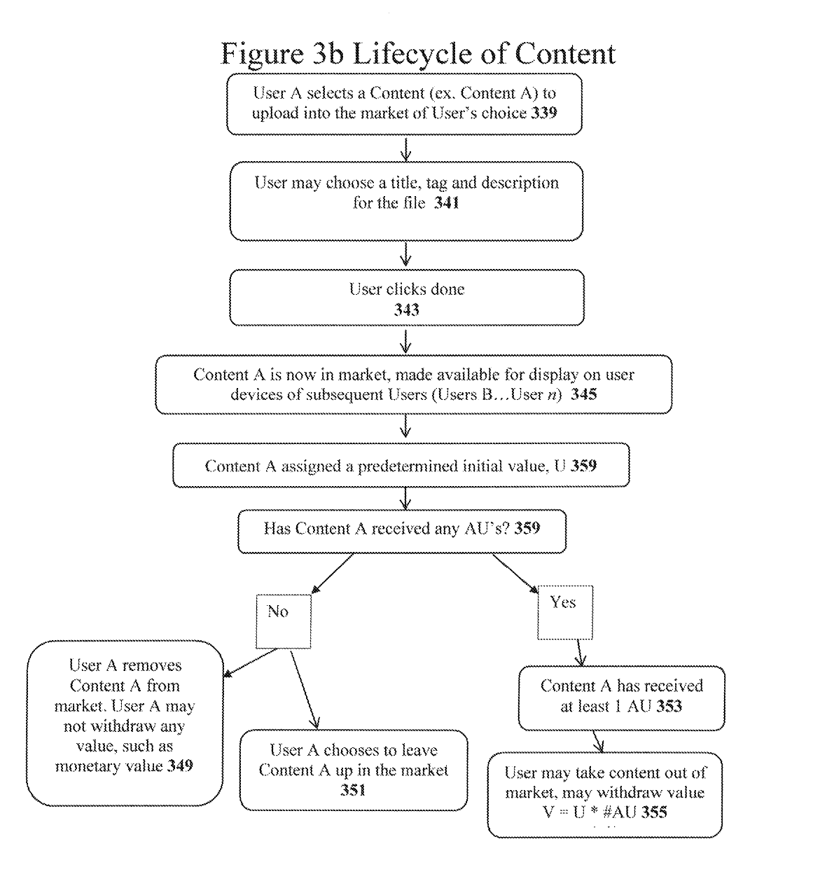

The details of the workings of each of these three main modules is illustrated in FIG. 3a. FIG. 3a is detailed flow chart showing the life cycle of content and illustrating the manner in which a content may be monetized in accordance with an embodiment of the system. For clarity of illustration, FIG. 3a shows only one content (Content A) uploaded by a user (User A) and the participation by one subsequent user (User B) in the content's valuation. Those skilled in the art will recognize that a plurality of users/subsequent users (Users A, B . . . n) may participate and that a plurality of content (Content A, B . . . n) may be valued in accordance by the system disclosed.

As shown in FIG. 3a, a user must first upload content 301 to the valuation platform 103. Upon entry to the valuation platform 103, the content is then received by the valuation platform's 103 CGE 123. The method performed by at least one processor at the CGE 123 includes the receiving Content A 303 and generating at least one “Approval Unit” (AU) corresponding to Content A. (AU's are the units by which subsequent users indicate their approval of content via the system. A user's content is valued, at least in part, based on the approval received by subsequent users, and these AU's are part of how this valuation is accomplished. This will be explained later). The preferred embodiment generates 1 AU for each 1 Content posted, however any predetermined number of AU's may be created to correspond with every content. The AU created upon receipt of Content A at the CGE 125 is next pooled into a pool of AU's 309. This pool may be any AU's previously generated by the CGE for other content (and not yet applied to content).

Once Content A is received 303, the content is then made available for display 307 on the user device of User B 323. At this point, Content A has not yet received any approval from any subsequent user. The VDE 125 meanwhile assigns Content A a predetermined base value, U 321. This base value, U, may be any determined value, monetary or virtual. For instance, it may he $0.50 or (if virtual) for example, 5 “tokens.”

If User B chooses to approve of Content A, he or she may indicate his or her approval by assigning an AU from the pool of AU's to Content A, 313. When User B performs this action, the pool of AU's decreases by 1 AU.

Because Content A now has received 1 AU, the value of Content A has increased 315. The determination of the value of Content A, V, is calculated by the formula

V=U*#AU,

where V is the value of any given content, such as Content A, U is a predetermined base value given to any content, for example $0.50. (see FIG. 5 for use of U in determining market value) and #AU is the number of AU's that the content has received. In this example, because Content A received 1 AU, thanks to User B's participation, the value of Content A (assuming a U of $0.50) is now realized at $0.50.

Continuing with FIG. 3a, once User B has assigned an AU to Content A 313, User B is rewarded 357. This is done preferably by assigning a reward (a “knack”) 325 to User B. This is performed at the IE 129 because the reward of the knack is an incentive for ensuring User B's participation in assigning AU's to other users' content. In order to serve as an incentive, the knack may be used, for example as a token or credit redeemable for future User B content uploads. Other rewards may be assigned 327, such as additional free uploads, access to secondary systems or features of the system's consumer facing website, etc.

FIG. 3b serves to show the process using an example Content. Content A from a consumer-facing perspective. This Figure is to provide additional context for the system disclosed. First, the user, ex. User A selects Content A to upload into the market of User A's choice 339. At this point, the system may incorporate varying user experiences. One may be that the user may select a title, tag, and description for the file 341. After clicking “done” 343 (other similar operations may be used). Content A is in the market and made available for display at user devices of subsequent users 345, the subsequent users being non User A users, User B . . . n.

As explained in FIG. 3a, Content A is assigned a predetermined base value, U. the monetization portion of the system is implicated when subsequent users assign AU' s from the pool of AU's in Content A's market to Content A (as opposed to other content in that particular market). The content in the market in a sense competes for the AU's in that market. The most approved content will be valued more highly than those that receive less approval. After a time has passed since the posting of Content A, at the option of User A, User A may withdraw Content A. The terms “post” and upload” are used synonymously herein; both refer to the action whereby a user takes the actions necessary at his or her user device to put Content (a data file which may be of various content types, such as audio, video, text, etc.) up on the system, via communication between the system's Valuation Platform and the user via the user device).

If User A wishes to withdraw Content A, the system will determine whether the Content A has received any AU's 359. If Content A has received no AU's, User A may remove Content A 349, but the content was not monetized (in other words, the User will have no value that can be withdrawn). This action will remove Content A from the market. It will no longer be displayed to subsequent users and the pool of AU's will decrease by 1 AU. The market value M (FIG. 5) will also decrease by 1U. Alternatively, Alternatively, User A may decide to leave Content A up in the market in the hopes that at some point a subsequent user will assign an AU to its Content and Content A's value will increase with more time. If Content A has received at least 1 AU 353, User A may remove content A from the market and that triggers the option to withdraw V=U*#AU 355. If using the example in. Para. 48, the user may now withdraw/remove Content A and also withdraw all or a portion of the $0.50. This is accomplished by communicatively coupling the valuation platform via a communications network to a financial institution such as an ACH system for authorizing a transaction that checks with the financial institution for ensuring funds and authorizing the transfer. In the preferred embodiment, all money taken in by owners and operators of the system (for paid upload) would create a separate bank account wherein these deposits would be made and at withdrawal, that account or accounts would authorize the transfer of the value V to the user, potentially less a transaction fee.

It is understood that content as used herein refers to an item of content, such as an image, video, blog post, or other media content. Because “content” may be both a singular or plural term, the term is used in singular in the context this specification is discussing a discrete transaction with the system. It is understood that the system may be used by many Users who upload a content or multiple items of content. Therefore, the use of “content” should be taken in conjunction with its context throughout. The content may be any content capable of being posted to a terminal and displayed on a user interface.

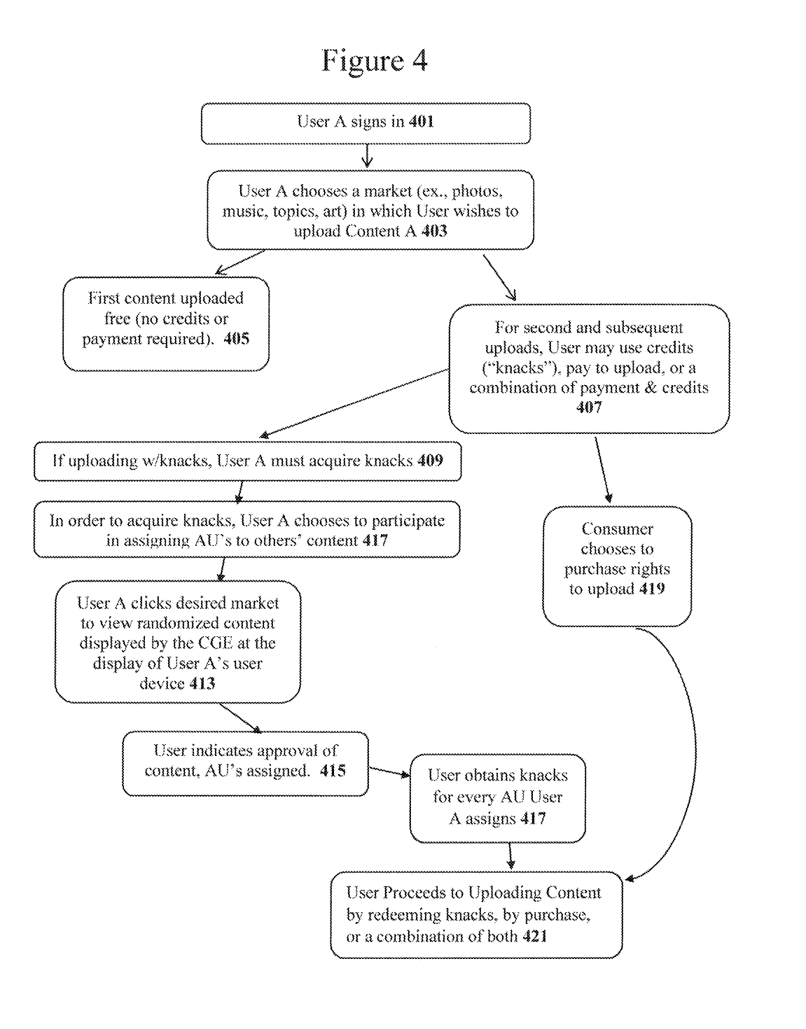

It should be pointed out here that the system is self-funding, which is shown in FIG. 4. One unique feature is that all content posted to the system has a predetermined base value U, even though the user posting the content is not required to pay the base value U to upload its Content to the system. This U is used in determining the overall market value M (FIG. 5) which M is distributed, in whole or in part, to the various content in the market by the VDE. Although it is counterintuitive that the system would be self-funded, the system is actually self-funded in practice because users have the option of free uploads (if they reach a certain level of participation in the valuation schema and have acquired sufficient knacks to redeem for permission to post second or subsequent content) or paid upload (no participation required). In practice therefore, a small percentage of users will choose paid upload because not everyone will have the time or energy to participate in the assignment of AU's to the content.

A separate system which dynamically prices the cost of paid upload in order to fund this system is a separate system not included in this disclosure. It is sufficient here to say that in the preferred embodiment, the first upload is “free” in the sense that no monetary value, virtual currency, or credits are required to be exchanged or redeemed in order to upload the first content. After the first upload, a user may either pay a predetermined amount of money to upload content, or they may upload in exchange for a certain type of credit created by the system. These credits are called “knacks” herein and users may redeem a certain predetermined number of these knacks in order to upload a second (or third, fourth . . . nth) content. Knacks are rewarded to users when they participate in assigning AU's to content. The number of knacks required to be redeemed at upload is a dynamically generated number and a separate system not part of this disclosure and not required for the full disclosure of the presently disclosed system.

In other words, content may be posted free of charge so long as a person has built up a certain number of credits (“knacks”). These knacks are accumulated by users by their participation in the valuation schema Because this does not require payment to upload content, the system ensures the participation of users in the valuation of content. People with no money to enter a market by uploading their content to it still have subjective opinions on content (of others). Because most people will want to use the free version of the system, the system self generates users by incentivizing participation.

In the event a user does not have time to view and indicate approval of content, it may purchase the right to upload. In this manner, the system ensures money is available to pay the base value, U, on the various content. It should be noted here that to the extent the disclosure refers to “crowd participation” or “user participation” these terms refer to the same thing.

Continuing with FIG. 4 therefore, a user, ex., User A signs in to the system 401 at her user device. The user may have photos, short stories, videos or other files of content on her computer. If she wishes to upload a photo of a dog, she will chose a market (a. category) in which the Content will be uploaded 403 (ex. pet photos). Assuming in this example that User A has never posted content before, her first upload is free 405. If this is any time after her first upload, the user must redeem a predetermined number of knacks or pay to upload the content on the valuation platform 407. If User A has no money, she will have to upload using knacks. (Recall from FIG. 2 that knacks are acquired by the participation of users in the assigning of AU's to other users' content.) In order to upload by redeeming knacks, User A will first need to acquire knacks 409. In order to do so, she must participate in assigning AU's to others' content 411. This mean she must click around in one or a plurality of markets and indicate approval of various items of content randomly displayed on the display of her user device 413. For every AU assigned by User A to the content 415, she receives 1 knack 417 in the preferred embodiment. It should be pointed out that in order to obtain knacks, there must be AU's remaining in the pool of AU's for any given market. For any given market, the VDE may display or otherwise make known (via communication with the user device 107 over the network 109) to the users the number of AU's remaining for distribution. If there are no AUs remaining in the pool, then the User must go into another market in order to assign AU's and ultimately acquire knacks.

If the user does not have the time to go through the process of acquiring knacks, User A may simply purchase the right to upload subsequent content 419. The user may also redeem a certain number of knacks to upload (meaning that no monetary currency is required for subsequent upload), or the user may use a combination of purchase and knacks 421. The number of knacks that are required to upload content (without making any supplemental purchase) into any given market is dynamically generated and is proprietary. It is sufficient to say here that the system does require a certain number of knacks to be redeemed for each subsequent content upload (uploads that are not free uploads).

FIG. 5 is a flowchart showing the determination of a market value for a given category of content. The market value refers to a number value generated as the value of the market as a whole for the purpose of determining pricing for paid uploads or the numbers of knack credits that must be redeemed in order to enter into that market. Market value also refers to the value of the market as a whole which is to be distributed, in whole or in part, to the individual content in that market by the VDE in conjunction with the crowd. A market refers to a category of content. For instance, there may be a pet photos “market.” This is a category of content. Therefore, while the term “market” is used, the reader should understand that these are not markets in the traditional sense of trading—there is no trading or sale of the pet photos in the embodiment disclosed.

The market value is determined by assigning each content upload a one-time discrete value U 505 (called “base value”) and multiplying U by the number of content in the market 507a,b at the time the market value is determined. U is preferably monetary and may be any number, but the system operates best at low dollar values. For instance, each upload may be assigned a value of $0.75. This “base value” (“U”) is assigned to any content, regardless of commercial value. The whole market would then have a total value M. It is this value M that is distributed amongst content in that market, through participation of the crowd in assigning AU's. The system then uses crowd based behavior to generate a “value” V for each individual content, for ex. Content A, where V=U*#AU. This equation says that the value of a given content is its base value plus the base value multiplied by the number of AU's the content has received from various subsequent users (users other than the user who posted the content). For instance, if U is predetermined to be $0.75 and Content A receives 3 AU's, the value determined by the system will be $2.25.

Crowd participation is required in order to generate this value. Therefore the system may be thought of as a system for generating a concrete value on subjective opinions (approval of content, liking of content). This system is unlike commercial enterprise idea markets which “trade” in ideas because, for one, there is no downside to posting content or assigning approval units to any content. One issue inherent in trading is that there is a bias against commercial success of the underlying content. One example are enterprise idea markets. Because those systems are intended for use within an organization (due to containing trade secrets), employees “trading” in the ideas are inclined to purchase the most commercially successful idea. There is also a disincentive for participation when some potential traders, nervous to pick losing ideas and therefore be perceived within an organization as poor predictors of commercially viable ideas, chose simply not to participate.

The current system eliminates this practicality-bias. There is no bias against users who select content based on purely subjective reasons. Also, because the system is used by remote users regardless of location or affiliation, there is no risk that the users' decisions to knack certain content be perceived as “good” or “poor” selections. Preferably, the system is private as to each individual's success in the market (success such as obtaining a high knack return (discussed below). Also, while each individual is competing against each other for knacks, in order to compete, they must also endorse their competitors by assigning AU's to other content (users cannot assign AU's to their own content). Users are also discouraged from picking deliberately weak content. This is via knack return. In order to obtain more knacks, the user must pick what they deem to be the best content.

Incentive Engine

The system requires crowd participation (crowd refers to a plurality of users) to value content. This is because the system needs at minimum, crowd participation for assigning AU's to content. Without crowd participation, the content could not be valued using the disclosed system. Theoretically, users participate of their own desire, without incentive. However, incentives are preferred. The crowd is preferably a plurality of human users, but may be a plurality human or non human users for participating in the assignment of AU's, for instance, programmed computers using artificial intelligence together or in combination with human users.

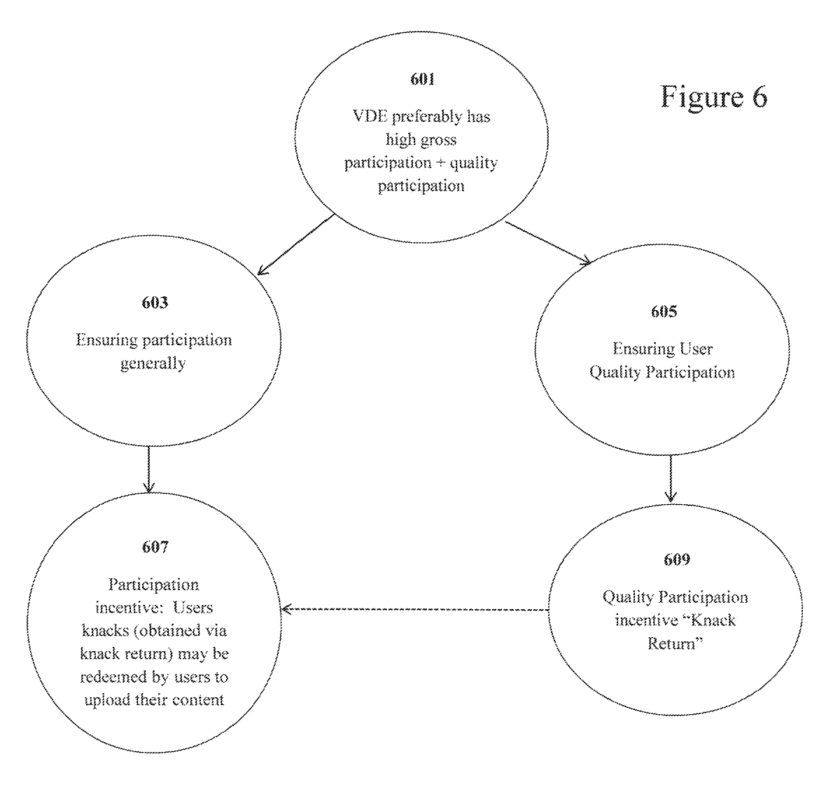

FIG. 6 shows a high level diagram introducing the IE 129. As shown, the Value Distribution Engine needs participation of users in order to distribute the market value M amongst content. The VDE functions optimally if there is both participation and quality participation 601. While the system may function with user initiated interaction with the system (all self motivated. participation), the IE incentivizes participation. To incentivize participation generally (gross participation) 603, the incentive is that a predetermined reward is given, preferably every time a user assigns an AU 607. In the preferred embodiment, these are the knacks which were referenced above. To discourage users from simply assigning AU's at random in order to get the knack reward quickly, the system's IE also ensures quality participation 605. This is done by an incentive for rewarding users who assign AU's to content which is approved of by other users.

The system may therefore include a module called the Incentive Engine (IE) 129 for encouraging both gross crowd participation as well as quality crowd participation. The Incentive Engine 129 in the preferred embodiment has two main incentives (1 “knacks™” and 2. “knack return™” described below), but one or both, or other incentives or combination of incentives may be used.

The first incentive for encouraging crowd participation is that if the crowd participates, it is rewarded with rewards called “knacks.” As used herein a “knack” is a reward, a credit, that a user may redeem (in various quantities) for permission to upload their own content. Users preferably acquire 1 knack each time they assign an AU to a content (although more than one, such as a predetermined plurality of knacks, may be rewarded).

The number of knacks required to be redeemed for permission/rights to upload content is determined by a proprietary process not part of the system disclosed; it is sufficient to say that a certain number of knacks are required to upload content in a given category based on a number of factors at any given time. If the user has acquired the requisite number of knacks required to upload the user's content a given category, the knacks are redeemed at the time of upload and no payment is required fir the user to upload their content (free upload). If the user does not have a sufficient number of knacks (or no knacks at all), they may supplement with a monetary payment (in whole or in part) in order to upload content. (The determination of the price that must be paid to upload is also determined by a proprietary process not part of the system disclosed). Therefore, the incentive of knacks rewarded may also be seen as participation for a reward of free or reduced payment content upload.

As stated previously, the system preferably incentivizes not only participation, but quality participation. “Qualify” crowd participation means that the AU's assigned to the content reflect the crowd's genuine subjective opinion of approval on the various content. Otherwise, individuals may just click random content in order to obtain knacks, but not necessarily content that the user actually approves of. (“Click”ing refers to the operation in the User Experience (UI) whereby a user indicates approval of content and assigning of an AU to a content. Other UI may be employed without departing from the scope of the disclosed system). The incentive for quality participation is done via a process known herein as “knack return.”

Simply, knack return is a reward where users who approve “good content” ate rewarded, especially if the user approves “good content” early. As described above in the discussion of the VDE, the value of content is based on the number of AU's that content receives. Knack return rewards a user, in knacks, when content which was approved of by that user is later approved of by at least two more users. In other words, knack return is a reward whereby users, who select content that is approved of by at least two subsequent users, receive knacks. The quantity of knacks received in knack return is determined may be any predetermined level of reward, but in the embodiment disclosed is 3% of the user's current balance of knacks (“knack balance”).

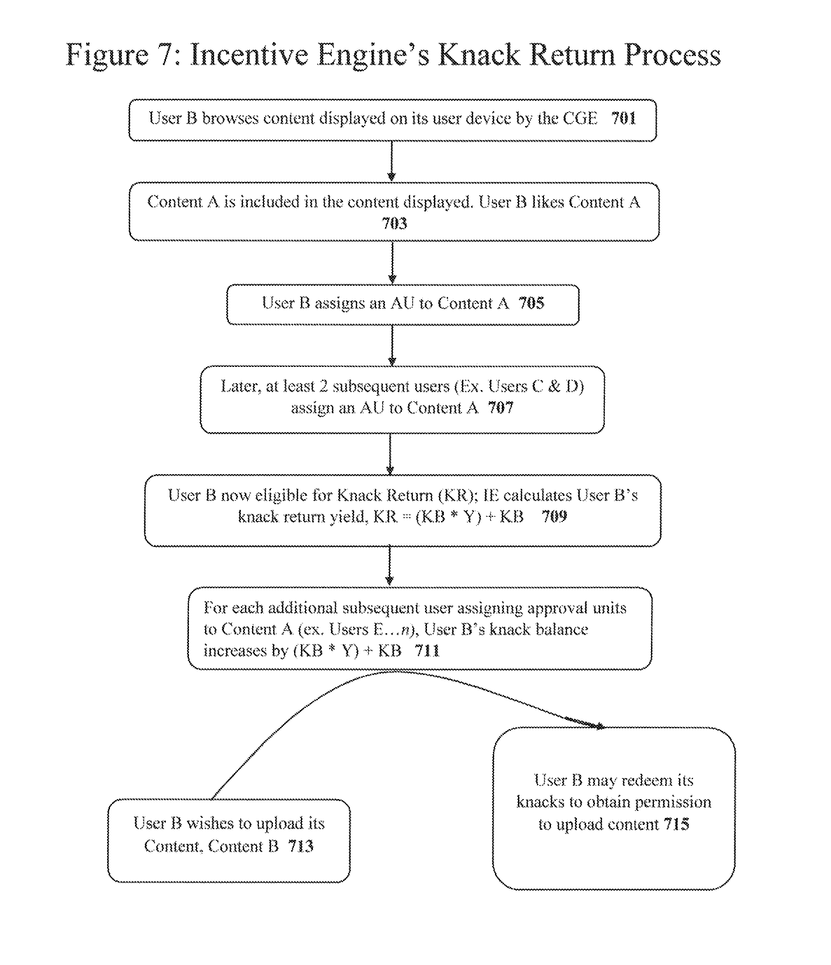

In the paragraphs that follow, the process of knack return will be explained as outlined in FIG. 7. Then, because the process is not intuitive, an example is using example users and an example content is provided.

First, FIG. 7 shows a flowchart of the knack return process performed at the IE. This example uses an example user, User B, and an example content Content A. As a recap of the discussion on FIG. 2, users of the system interact with the valuation platform 103 at various modules depending on the user's chosen action. There are two main actions in the preferred embodiment that users may take. These are viewing and uploading content (at the CUE 123), and assigning AU's to content (in communication with the VDE 125). The IE 129 feeds information back to the users concerning, such as information on the users' knack balances and whether the users have received any knack return.

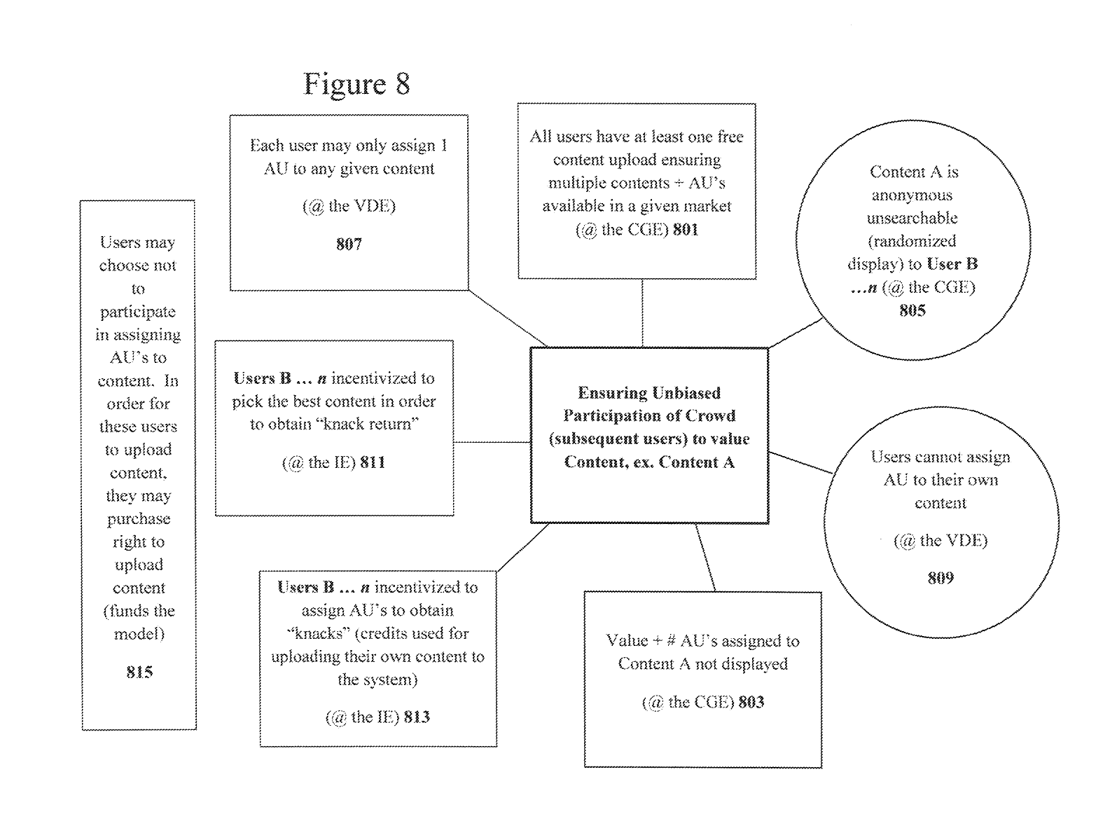

It should be noted here that users of the system may interact with the system at the CUE 123 and VDE 125 at connections 207 and 205 respectively, via network 109, as shown in FIG. 2. This is because users may interact with the system to post their own content at the CGE 123 and also at the VDE 125 to participate in valuation. The IE 129 preferably interacts with the user via network 109 unidirectionally, as shown 201. This is to illustrate that when a user participates with the VDE 125, the VDE will communicate with IE 129 as to the reward to give to the user via connection 203. However, the user cannot access the IE to determine certain data concerning the content that is not their own, such as how much approval that content has received from others, how much that content is currently valued by the system, or other information. It is also believed that this illustration demonstrates the configuration of the IE 129 as shown in FIG. 8. (discussed later).

FIG. 7 provides a knack return process embodiment. On its user device, User B browses the displayed content (Content. A . . . n) which are displayed randomly by the CGE. In this example, User B likes Content A 703. Later, at least 2 subsequent users (Ex. Users C&D) also browse the randomized content in the market and each assign an AU to Content A as well. 707. After this event, User B is now eligible for Knack Return. At this point the UE 129 calculates User B's knack return yield using the equation

KR=[(KB)*Y]+KB 709

where Y is any predetermined reward percentage, KR is Knack Return, and KB is Knack Balance at the time of eligibility for new Knack Return reward For example, if User B's current KB is 150 and assuming Y is 3%, if User B is now eligible for KR, the KR will increase User B's KB to [(KB*3%)+KB]. User B new KB=154.5=[(150*3%)+150)], an increase by over 4 knacks.

For each additional subsequent user that assigns AU's to Content A, User B's knack balance will increase by [(KB)*Y]+KB 711. Blocks 713, 715 demonstrate that the knacks rewarded via KR may be redeemed for permission for User B to upload content. Because the preferred system contemplates a free first content upload, knacks obtained by User B (via knack return or via assigning AU's) may be redeemed for permission to upload their 2^{nd} . . . nth content.

The amount of knacks rewarded may vary, but in the example shown in the Figures, a user is rewarded 3% of its current knack balance each time a person approves of content after the user ]

Example Showing how eligibility for Knack Return is determined, Example Content A uploaded by User A (“Emily”)

| | AU's | | Who is Eligible |
|---|---|---|---|
| Value_{Content A}, if | Assigned to | | for Knack |
| U = $0.85 | Content A | Who assigned the AU? | Return (“KR”)? |
| $0.85 | No AU's yet | n/a | No one |
| | assigned. | | |
| | V = Base | | |
| | Value | | |
| $1.70 | First AU | Zoe (ex. User B) | No one |
| $2.55 | Second AU | Violet (ex. User C) | No one |
| $3.40 | Third. AU | Lexi (ex. User D) | Zoe (1^{st} KR) |
| $4.25 | Fourth AU | Jake (ex. User E) | Zoe (second |
| | | | KR), Violet (1^{st} |
| | | | KR) |
| $5.10 | Fifth AU | Maraya (ex. User F) | Zoe (third KR), |
| | | | Violet (second |
| | | | KR), and Lexi |
| | | | (1^{st} KR) |

Example showing knack return for Zoe, Violet, and Lexi, assuming Y=3%

| | Knack Balance at | |
|---|---|---|
| | time of Knack | |
| User | Return | Knack Balance after Knack Return |
| Zoe | 2 | 1st KR: |
| | | (2 * 0.03) + 2 = 2.06 |
| | | 2^{nd} KR: |
| | | (2.06 * 0.03) + 2.06 = 2.12 |
| | | 3^{rd} KR: |
| | | (2.12 * 0.03) + 2.12 = 2.18 |
| Violet | 100 | 1st KR: |
| | | (100 * 0.03) + 100 = 103 |
| | | 2^{nd} KR: |
| | | (103 * 0.03) + 2103 = 106.1 |
| Lexi | 200 | 1^{st} KR: |
| | | (200 * 0.03) + 200 = 206 |

Because of human nature, some categories will contain more uploads and attract more participation than others. For instance, certain genres of books (ex. teen vampire books) seem to get more attention from the public than say, reference books. Therefore, surely some categories of content will attract more participation than others. As an example, one category could he vampire romance novels and one could be mural art. Of the two categories, vampire romance novels might get more traffic than mural art. However, one advantage is that although a niche category, mural artists will still be able to attract niche crowd participation (because it is likely users who enter that category to assign approval units in “mural art” are attracted to mural art at some level), and the content owners will still be able to value their content using the system. (While the traffic variations between different categories is used in the determination of the price to upload and the number of knacks required to enter those categories, the process by which that is done is not a subject of this disclosure).

Because the system disclosed is complex, FIG. 8 has been provided to serve as an illustration of the preferred configuration of the Valuation Platform's three main modules and how they work together to ensure unbiased participation of a crowd to value content. The disclosed features are preferred, but it is contemplated that the system may include some or any combination of these features. For example, at the CGE all users have at least one opportunity for free content upload 801, which ensures that multiple contents and AU's will be available in a given market, because there is no barrier to entry. The CGE which serves to display content to the crowd for valuation displays the content so as not to include any information about that content (such as the current value or number of AU's the content has received thus far). 803. This reduces the subconscious tendency to value content based on the content's current peer appraisal. Users are instead forced to rely on their own opinions as to the content when deciding whether to assign an AU to it. Another display feature is that the display is randomized and unsearchable 805. This means that users will not be able to encourage their friends to find and assign AU's to their content.

The VDE also functions so as to do its part to eliminate bias in crowd participation. For one, each user can only assign a certain predetermined number of AU's to any one given content 807 (1 AU per 1 Content in the preferred embodiment). This discourages bots from auto assigning AU's to one particular content. Also users cannot assign an AU to their own content 809, which serves to limit self-selecting bias. Finally, the IE ensures quality participation by the knack return 811 and knack 813 rewards, as previously discussed. Finally block 815 serves as a reminder that a user does not have to participate in the assignment of AU's in order to have his or her content valued. In that case he or she may simply purchase the rights to upload content (after the initial free upload).

It should be noted that nowhere in this disclosure has been disclosed a manner in which the content's valuation decreases. Using the system disclosed, users have no risk of value loss in their content, and the hope is that their content will receive at least a few AU's. This configuration, as a whole, also ensures the perpetuation of the model because it leverages a low barrier to entry with the emotional hope of social validation (and monetization). Content creators are generally creative and content posters typically have some confidence in their content. Because there is no risk to using the system (content does not decrease in value in the preferred embodiment), the system will attract many initial entrants who will vie for the “pie” represented by the market value M.

Architecture

FIG. 1 shows an exemplary system 100 for implementation of the disclosed technology, including a central processing unit (or processor) 117 and a communication bus (“bus”) 121 that couples various system components including the system memory 115 to the processor 117, which is a hardware processor. Modules, ex. 123, 125, 129 may be configured to control the processor 117 to perform various actions. Memory 115 can include multiple different types of memory with different performance characteristics and may be read only memory and random access memory. The disclosure may operate on a computing device such as user devices 107 with more than one processor 117 or on a group of networked computing devices. The processor 117 may include any general purpose processor and a hardware module or software module communicatively coupled with modules CGE 123, VDE 125, and preferably also IE 129 having storage 113 (which may be remote), where the modules are configured to control at least one processor 117 to perform the methods disclosed. The processor 117 may be a completely self-contained computing system, containing multiple cores or processors, a bus, memory controller, cache, etc. A multi-core processor may be symmetric or asymmetric.

The bus 121 may be any of several types of bus structures including a memory bus or memory controller, a peripheral bus, and a local bus using any of a variety of bus architectures. A basic input/output (BIOS) stored in read only memory or the like, may provide the basic routine that to assist in the transfer of information between elements within the computing device 2200, such as during start-up. Although storage 111, 113 is shown as a remote storage communicatively coupled with the Valuation Platform 103 as well as storage housed within the Valuation Platform 103, embodiments are contemplated having storage located within the Valuation Platform 111 only, or remote only, or both. The system 100 further includes storage 113 such as a hard disk drive, a magnetic disk drive, an optical disk drive, tape drive or the like. Storage 113 may include software modules for controlling the processor 117. Other hardware or software modules are contemplated. The storage 111 is connected to bus 121 by a drive interface. The drives and the associated computer-readable storage media provide nonvolatile storage of computer-readable instructions, data structures, program modules and other data for the system.

In one aspect, a hardware module that performs a particular function includes the software component stored in a non-transitory computer-readable medium in connection with the necessary hardware components, such as the processor 117, bus 121, display (not pictured, but located on the user device 107), and so forth, to carry out the monetization system disclosed. The “display” refers to visually perceptible display on a display device (such as a networked computing device (user device) 107 which is a user's computing device) resulting from a tangible computer file stored in its memory. This may originate from across a network 109, such as the Internet, a wireless communication network, or a system of connected networked computers. The display includes devices upon which information can be displayed in a manner perceptible to a user, such as a touchpad or touchscreen display, a computer monitor, an LED display, and the like means known in the art for producing visually perceptible output. The basic components are known to those with skill in the art and appropriate variations are contemplated depending on the type of device; the term “computing device” (also “user device”) 107 refers to any device with processing capability such that it can execute instructions, such as smartphones, PC computers, servers, telephones, and other similar devices.

Although the exemplar embodiment of the system 100 described herein employs the hard disk, storage 111, 113, Valuation Platform 103, and users connected to the Valuation Platform 103 via a network 109 via their user devices 107, those skilled in the art appreciate that other types of computer-readable media may also be used in the exemplary operating environment. Non-transitory computer-readable storage media expressly exclude media such as energy, carrier signals, electromagnetic waves, and signals per se.

To enable user interaction with the Valuation Platform 103, the user device 107 serves as an input device, which represents any number of input mechanisms, such as a microphone for speech, a touchscreen for gesture or graphical input, keyboard, mouse, motion input, speech, etc. which may be housed on the user devices. The user devices also comprise a number of output mechanisms know to those of skill in the art. In some instances, multimodal systems for enabling a user to provide multiple types of input to communicate with the Valuation Platform and its various modules 123, 125, 129. A communications interface 131 generally governs and manages the user input at User Device 107 and Valuation Platform 103's output to the user device 107. There is no restriction on operating on any particular hardware configuration and the basic componentry here may easily be substituted for improved hardware or firmware arrangements as they are developed.

The preferred system embodiment is presented as including individual functional blocks including functional blocks labeled as a “processor” or processor 117. The functions of one or more processors may be provided by a single shared processor or multiple processors. (The term “processor” should not be construed to refer exclusively to hardware capable of executing software.) Illustrative embodiments may include microprocessor and/or digital signal processor hardware, read only memory for storing software performing the operations discussed above, and random access memory for storing results.

The logical operations of the various embodiments are implemented as: (1) a sequence of networked computer implemented steps, operations, or procedures running on a programmable circuit within the valuation platform 103, together with the user interaction across the network 109, (2) a sequence of computer implemented steps, operations, or procedures running on a specific-use programmable circuit; and/or (3) interconnected machine modules or program engines within the programmable circuits. The system 100 can practice all or part of the disclosed methods and/or can operate according to instructions in the recited non-transitory computer-readable storage media. Such logical operations can be implemented as modules configured to control the processor 117 to perform particular functions according to the programming of the modules, which may be CGE 123, VDE 125, and preferably also the IE 129. For example. FIG. 1 illustrates three Modules, 123, 125, 129, which are modules controlling the processor 117 to perform particular steps or a series of steps, however additional or fewer modules may be used (for example, the system 100 does not require the IE 129, although it is preferred). These modules may be stored on the storage 111 and loaded into random access memory or memory 115 at runtime or may be stored as would be known in the art in other computer-readable memory locations.

Variations

The system may be used to value content, but does not require a user to monetize or extract a financial gain from the content. The system's valuation platform may be used to ascertain a value of content for use to prove market value should a user wish to sell or license its content in another forum. In the preferred embodiment, however, users who see their content increase in value may utilize the system to receive a monetary payment upon withdrawal of their content from a market.

The system is counterintuitive, as there is no other known system whereby a content, uploaded to a system, can only increase in value, even when no currency has been paid into the system, let alone sustainable. Yet this system is sustainable due to the intricate connection of the users (the “crowd”), the CGE, the VDE, opportunities for paid upload (in lieu of redeeming knacks), and preferably the IE.

1. A system for determining the value of a content comprising a valuation platform, the valuation platform further comprising
a content grouping engine to
receive content at at least one server of the valuation platform from at least one user;
group the content into categories of content;
determine a market value for any given category of content;
a value distribution engine to
distribute at least a portion of the market value to content based on approval received from a crowd of users as to any given content, wherein the portion of the market value distributed to the content is the content's value;
and an incentive engine for rewarding the crowd of users for quality participation in the approval of content;
wherein the system further comprises at least a processor, memory, and hardware for communicatively coupling the valuation platform to the at least one user and the crowd of users over a network.

2. The system of claim 1, communicatively coupled via computer or computers to a banking institution for payment of the value of the content.

3. The system as in claim 2, wherein the steps are performed by a computer or computers within an automated system that is in communication with the Federal Reserve Automated Clearing House system.

4. The system as in claim 1 wherein
the content grouping engine creates a predetermined number of approval units when content is uploaded to the system;
and wherein the approval received from a crowd of users comprises an indication of approval by at least one user, the indication causing a predetermined number of approval units created by the content grouping engine to be assigned to the content.

5. The system as in claim 4, wherein the content grouping engine assigns a predetermined base value to each content received and wherein the market value comprises the sum of the base value for all content in a given category of content.

6. The system as in claim 1, wherein the processor causes the content grouping engine to perform a method for creating a pool of approval units for use in indicating approval of content shared over a network via the valuation platform, the method comprising the steps of:
receiving, at the valuation platform at least one content from a user;
generating at the content grouping engine a predetermined number of approval units corresponding to the at least one content;
pooling the predetermined number of approval units generated and making the pool of approval units available to at least one subsequent user;

7. The system as in claim 6, wherein the processor causes the value distribution engine to perform a method for distributing approval units from a pool of approval units to content shared over a network via a valuation platform, the method comprising the steps of:
receiving input from the at least one user comprising an indication of approval of a content;
assigning at least one approval unit from the pool of approval units to the content approved;
removing approval units from the pool of approval units corresponding to the number of approval units assigned to content.

8. A system for valuing content, the system comprising at least a
a valuation platform for determining a value of a content, the valuation platform comprising at least a content grouping engine communicatively coupled with a value distribution engine, the valuation platform further comprising at least storage, memory, and at least one processor,
at least two user devices communicatively coupled to the valuation platform via a communication network,
wherein at the content grouping engine the at least one processor performs a method for creating a pool of approval units for use in indicating approval of content shared over the communication network via the valuation platform, the method for creating a pool of approval units comprising the steps of:
receiving at at least one server of the valuation platform, at least one content from a user;
generating a predetermined number of approval units corresponding to the at least one content;
pooling the approval units into a pool of approval units and making the pool of approval units available to at least one subsequent user;
wherein at the value distribution engine the at least one processor performs a method for distributing approval units from a pool of approval units to content shared over the network via the valuation platform, the method for distributing approval units comprising the steps of:
receiving input from the at least one subsequent user comprising at least an indication of approval of a content;
assigning at least one approval unit from the pool of approval units to the content approved by the at least one subsequent user;
removing approval units from the pool of approval units corresponding to the number of approval units assigned to the content approved by the at least one subsequent user;
wherein the value of the content correlates to the number of approval units assigned to the content.

9. The system of claim 8, further comprising an incentive engine for rewarding users for indicating their approval of content.

10. The system of claim 8, wherein each approval unit has a predetermined value.

11. The system of claim 8, wherein the value is monetary.

12. The system of claim 8, wherein the number of approval units assigned to the content is determinative of the value of the content.

13. The system as in claim 7 wherein
the content grouping engine creates a predetermined number of approval units when content is uploaded to the system;
and wherein the approval received from a crowd of users comprises an indication of approval by at least one user, the indication causing a predetermined number of approval units created by the content grouping engine to be assigned to the content.

14. The system as in claim 8, wherein the content market engine assigns a predetermined base value to each content received and wherein the market value comprises the sum of the base value for all content in a given category of content.

15. (canceled)

16. The system as in claim 1, wherein the processor causes the value distribution engine to perform a method for distributing approval units from a pool of approval units to content shared over a network via a valuation platform, the method comprising the steps of:
receiving input from the at least one user comprising an indication of approval of a content;
assigning at least one approval unit from the pool of approval units to the content approved;
removing approval units from the pool of approval units corresponding to the number of approval units assigned to content.

17. A non-transitory, tangible computer readable storage medium for storing instructions to perform a method for valuing content on a valuation platform via interaction with a crowd of users over a communication network, the method comprising
receiving at at least one server of the valuation platform content from at least one user;
assigning a predetermined base value to the content;
generating a market value comprising the sum of all base value of all content received;
distributing the market value to content based on input received from a crowd of users, said input entered on a user device communicatively coupled to the valuation platform via a communication network;
wherein the method is performed by a processor of the valuation platform, in communication with the crowd of users via the at least one user device: and
wherein the wherein the distributing the market value step is performed by a value distribution engine having at least one processor for performing a method for distributing approval units from a pool of approval units to content shared over the communication network via the valuation platform, the method for distributing approval units comprising the steps of:
receiving input from the at least one subsequent user comprising at least an indication of approval of a content;
assigning at least one approval unit from the pool of approval units to the content approved by the at least one subsequent user;
removing approval units from the pool of approval units corresponding to the number of approval units assigned to the content approved by the at least one subsequent user;
wherein a value of the content is determined and correlates to the number of approval units assigned to the content.

18. The system as in claim 1, wherein a user's participation is deemed quality participation when a predetermined number of subsequent users participate by assigning approval units to the same content as assigned by the user.

19. The system of claim 9, wherein the incentive engine rewards the users for quality participation in the approval of content.

20. The system as in claim 19, wherein a user's participation is deemed quality participation when a predetermined number of subsequent users participate by assigning approval units to the same content as assigned by the user.
